(19) United States
(12) Patent Application Publication
(10) Pub. No.: US 2026/0312728 A1
(43) Pub. Date: Oct. 8, 2026

(54) METHOD AND APPARATUS FOR ALLOCATING MASKING PATTERN OF POLAR CODES TO PREVENT FALSE ALARM IN WIRELESS COMMUNICATION SYSTEM

(71) Applicant: SAMSUNG ELECTRONICS CO., LTD., Suwon-si (KR)

(72) Inventors: Jonghwan KIM, Suwon-si (KR); Hongsil JEONG, Suwon-si (KR)

(73) Assignee: SAMSUNG ELECTRONICS CO., LTD., Suwon-si (KR)

(21) Appl. No.: 19/635,248

(22) Filed: Mar. 31, 2026

Related U.S. Application Data
(63) Continuation of application No. PCT/KR2026/004995, filed on Mar. 30, 2026.

(30) Foreign Application Priority Data
Mar. 31, 2025 (KR) 10-2025-0041722
May 8, 2025 (KR) 10-2025-0060023

(51) Int. Cl. H04L 1/00

(52) U.S. Cl. CPC H04L 1/0061

(57) ABSTRACT

A transmitter in a wireless communication system. the transmitter including: a transceiver; one or more processors including processing circuitry; and memory storing instructions. The instructions, when executed by the one or more processors individually or collectively, cause the transmitter to: for a plurality of signals to be transmitted, determine a maximum value of distances between a reference codeword vector and codeword vectors to be generated using decoding, determine a set of first values corresponding to difference vectors between at least two masking pattern vectors, based on the maximum value of the distances, determine masking pattern vectors for at least two receivers, based on at least one value in the set of first values, and mask bitstreams of the plurality of signals, using the masking pattern vectors.

### CROSS-REFERENCE TO RELATED APPLICATIONS

This application is a continuation of International Application PCT/KR2026/004995, filed on Mar. 30, 2026, which is based on and claims priority to Korean Patent Application No. 10-2025-0041722, filed on Mar. 31, 2025, in the Korean Intellectual Property Office, Korean Patent Application No. 10-2025-0060023, filed on May 8, 2025, in the Korean Intellectual Property Office, the disclosures of which are incorporated by reference herein in their entireties.

### 1. FIELD

The disclosure relates to a method and an apparatus for allocating a masking pattern of polar codes to prevent a false alarm in a wireless communication system.

### BACKGROUND

### 2. Description of Related Art

A review of the development of wireless communication from generation to generation shows that the development has mostly been directed to technologies for services targeting humans, such as voice-based services, multimedia services, and data services. It is expected that connected devices, which are exponentially increasing after commercialization of 5th generation (5G) communication systems, will be connected to communication networks. Examples of things connected to networks may include vehicles, robots, drones, home appliances, displays, smart sensors installed in various infrastructures, construction machines, factory equipment, and the like. Mobile devices are expected to evolve into various form factors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as “beyond-5G” systems.

6G communication systems, which are expected to be implemented approximately by 2030, will have a maximum transmission rate of tera (1,000 giga)-level bits for second (bps) and a radio latency of 100 μsec. That is, 6G communication systems will be 50 times as fast as 5G communication systems and have the 1/10 radio latency thereof.

In order to accomplish such a high data transmission rate and ultra-low latency, it has been considered to implement 6G communication systems in a terahertz band (for example, 95 GHz to 3 THz bands). It is expected that, due to more severe path loss and atmospheric absorption in the terahertz bands than those in mmWave bands introduced in 5G, a technology capable of securing the signal transmission distance (that is, coverage) will become more crucial. It is necessary to develop, as major technologies for securing the coverage, multiantenna transmission technologies including radio frequency (RF) elements, antennas, novel waveforms having a better coverage than OFDM, beamforming and massive multiple-input and multiple-output (MIMO), full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Channel coding is a technology that transmits a message with high reliability by using redundancy bits during data transmission, and to this end, the use of an error correcting code may be needed. Claude Shannon defined the maximum information transmission rate for which reliable communication is possible as “channel capacity,” and thereafter, many studies on error-correcting codes for approaching Shannon's channel capacity have been conducted. Starting from the classical codes such as the Hamming, Bose-Chaudhuri-Hocquenghem (BCH), and Reed-Solomon (RS) codes, various modern codes such as turbo codes, low-density parity-check (LDPC) codes, and polar codes have been proposed. In particular, the LDPC code is a representative channel capacity-approaching code, the polar code is a channel capacity-achieving code, and each has been adopted as a data channel code and a control channel code of a 5G NR (new radio) standard.

Among these, the polar code is an error-correcting code, and is the first code for which it has been theoretically proven to asymptotically achieve the channel capacity with a low decoding complexity as the code length increases, for various types of binary-input discrete memoryless channels (BI-DMC). Although there is no advantage in terms of decoding performance compared to existing LDPC and turbo codes when the proposed successive cancellation (SC) decoding is performed, decoding performance is significantly improved when successive cancellation list (SCL) decoding and SCL decoding utilizing a cyclic redundancy check (CRC) code or a parity-check (PC) code (CRC-aided SCL (CSCL) decoding) is used. In particular, the use of both CRC and PC codes through the 3^{rd} Generation Partnership Project (3GPP) 5G standardization process has ensured excellent decoding and error detection performance, and based thereon, the polar code has been adopted as an error correcting code for a control channel for enhanced mobile broadband (eMBB). Moreover, the polar code is particularly cited as a channel code candidate for beyond 5G (B5G) and 6G communications, based on strong decoding performance at a short length.

The background technology described above is technical information that the inventor possessed for deriving the disclosure or acquired in the process of deriving the disclosure and therefore cannot necessarily be considered as prior art publicly disclosed before the filing of the disclosure.

### SUMMARY

The embodiments describe herein propose a method and an apparatus for allocating a masking pattern of polar codes. The masking pattern may help prevent a false alarm in a wireless communication system.

The embodiments describe herein propose a method and an apparatus for allocating a polar code masking pattern which prevents the occurrence of a false alarm phenomenon. The allocation may be based on Hamming distance characteristics of the polar code and a CSCL decoding algorithm.

The technical subjects pursued in the disclosure may not be limited to the above-mentioned matters, and other technical subjects which are not mentioned herein may be considered from the following description of various embodiments of the disclosure by those skilled in the art to which the disclosure pertains.

According to an embodiment of the disclosure, a transmitter in a wireless communication system. the transmitter including: a transceiver; one or more processors including processing circuitry; and memory storing instructions. The instructions, when executed by the one or more processors individually or collectively, cause the transmitter to: for a plurality of signals to be transmitted, determine a maximum value of distances between a reference codeword vector and codeword vectors to be generated using decoding, determine a set of first values corresponding to difference vectors between at least two masking pattern vectors, based on the maximum value of the distances, determine masking pattern vectors for at least two receivers, based on at least one value in the set of first values, and mask bitstreams of the plurality of signals, using the masking pattern vectors.

In an embodiment, the instructions, when executed by the one or more processors individually or collectively, cause the transmitter to: generate codewords by encoding the masked bitstreams, and transmit the codewords to the at least two receivers.

In an embodiment, the instructions, when executed by the one or more processors individually or collectively, cause the transmitter to: set a second value corresponding to a list size for the decoding, and, based on the second value, determine a number of the codeword vectors to be generated using the decoding.

In an embodiment, an initial setting value of the second value includes a maximum list size for the decoding.

In an embodiment, the instructions, when executed by the one or more processors individually or collectively, cause the transmitter to: determine whether a size of a set of the masking pattern vectors is less than the number of the at least two receivers, in response to determining that the size of the set of the masking pattern vectors is less than the number of the at least two receivers, set the second value to a smaller value than a previously set value, and, based on the second value being set to the smaller value, determine a number of the codeword vectors to be generated using the decoding.

In an embodiment, the instructions, when executed by the one or more processors individually or collectively, cause the transmitter to: until the size of the set of the masking pattern vectors is greater than or equal to the number of the at least two receivers, repeat: in response to determining that the size of the set of the masking pattern vectors is less than the number of the at least two receivers, setting the second value to a smaller value than a previously set value, and based on the second value being set to the smaller value, determining a number of the codeword vectors to be generated using the decoding.

In an embodiment, the instructions, when executed by the one or more processors individually or collectively, cause the transmitter to: determine a set of values among the set of first values whose transformed values are greater than the maximum value of the distances.

In an embodiment, the decoding includes cyclic redundancy check (CRC)-aided successive cancellation list decoding, and the encoding includes polar encoding.

In an embodiment, the maximum value of the distances is determined based on a bit length of the plurality of signals to be transmitted and a codeword length of a polar code corresponding to the plurality of signals to be transmitted.

In an embodiment, the distances include Hamming distances.

In an embodiment, the masking pattern vectors correspond to a radio network temporary identifier.

According to an embodiment of the disclosure, a method by a transmitter in a wireless communication system. The method including: for a plurality of signals to be transmitted, determining a maximum value of distances between a reference codeword vector and codeword vectors to be generated using decoding; based on the maximum value of the distances, determining a set of first values corresponding to difference vectors between at least two masking pattern vectors; based on at least one value included in the set of first values, determining masking pattern vectors for at least two receivers; and masking bitstreams of the plurality of signals by using the determined masking pattern vectors.

In an embodiment, the method includes generating codewords by encoding the masked bitstreams; and transmitting the codewords to the at least two receivers.

In an embodiment, the method includes setting a second value corresponding to a list size for the decoding; and based on the second value, determining a number of the codeword vectors to be generated using the decoding.

In an embodiment, an initial setting value of the second value comprises a maximum value of the list size for the decoding.

In an embodiment, the method includes determining whether a size of a set of the masking pattern vectors is less than a number of the at least two receivers; in response to determining that the size of the set of the masking pattern vectors is less than the number of the at least two receivers, setting the second value to a value smaller than a previously set value; and based on the second value being set to the smaller value, determining a number of the codeword vectors to be generated using the decoding.

In an embodiment, the method includes until the size of the set of the masking pattern vectors is greater than or equal to the number of the at least two receivers, repeat: in case that the size of the set of the masking pattern vectors is less than the number of the at least two receivers, setting the second value to a value smaller than a previously set value, and based on the second value being set to the smaller value, determining a number of the codeword vectors to be generated using the decoding.

In an embodiment, the determining of the set of first values corresponding to difference vectors between at least two masking pattern vectors, based on the maximum value of the distances, comprises determining, among the set of first values, a set of values, of which converted values for the set of first values are greater than the maximum value of the distances.

In an embodiment, the decoding comprises cyclic redundancy check (CRC)-aided successive cancellation list decoding, and the encoding comprises polar coding.

According to an embodiment of the disclosure, a non-transitory computer-readable storage medium storing at least one instruction which, when executed by at least a part of at least one processor of an electronic device, causes the electronic device to perform at least one operation. The at least one operation comprises: for a plurality of signals to be transmitted, determining a maximum value of distances between a reference codeword vector and codeword vectors to be generated using decoding; based on the maximum value of the distances, determining a set of first values corresponding to difference vectors between at least two masking pattern vectors; based on at least one value included in the set of first values, determining masking pattern vectors for at least two receivers; and masking bitstreams of the plurality of signals by using the determined masking pattern vectors.

The embodiments described herein may enhance the demodulation capability of a receiver without increasing complexity and can reinforce the security of a polar code system. The embodiments disclosed herein may allocate a polar code masking pattern which prevents the occurrence of a false alarm phenomenon, based on a Hamming distance characteristics of the polar code and a CSCL decoding algorithm.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

The following drawings attached to this specification illustrate preferred embodiments of the disclosure and, together with the detailed description of the disclosure described below, serve to further understand the technical idea of the disclosure; therefore, the disclosure should not be interpreted as being limited to matters described in such drawings:

FIG. 1 illustrates a wireless communication system according to an embodiment of the disclosure;

FIG. 2 illustrates an example of a block diagram of polar encoding and decoding operations of a new radio (NR) physical downlink control channel (PDCCH) in an NR communication system according to an embodiment of the disclosure;

FIG. 3 illustrates an example of CRC-aided SCL (CSCL) decoding in a wireless communication system according to an embodiment of the disclosure;

FIG. 4 is a flowchart illustrating an operation of determining a CRC masking pattern by a transmitter (e.g., a base station) according to an embodiment of the disclosure according to an embodiment of the disclosure;

FIG. 5 illustrates a set of polar codewords when a CSCL decoder having a list size Lₘₐₓ is used according to an embodiment of the disclosure;

FIGS. 6A and 6B illustrate CRC pass codewords generated by a transmitter (e.g., a base station) by using masking pattern vectors according to an embodiment of the disclosure;

FIG. 7 is a flowchart illustrating an operation of determining a CRC masking pattern by a transmitter (e.g., a base station) according to an embodiment of the disclosure;

FIG. 8 is a flowchart illustrating an operation of a transmitter according to an embodiment of the disclosure; and

FIG. 9 is a block diagram illustrating a structure of a transmitter according to an embodiment of the disclosure.

The drawings are included as reference examples for facilitating the understanding of the disclosure, and are not limited to specific embodiments of the disclosure. The specific contents illustrated in the drawings may include descriptions to supplement the overall technical background and context of the disclosure, and may provide useful technical information even if not explicitly stated in the claims.

### DETAILED DESCRIPTION

Hereinafter, embodiments of the disclosure will be described in detail in conjunction with the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the present disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

In addition, the expressions “if” and “in case that” as used in the description or claims may be interpreted to mean “when” or “upon,” “in response to,” “based on,” or “according to” depending on the context, and these expressions may be interchangeably used. In addition, within a range that does not depart from the technical features of the disclosure, other expressions having a substantially same meaning may be used instead of the above-described expressions.

In addition, the expression that “information is configured (configure) from a transmitter (e.g., a base station)” in the description or claims may, depending on the context, mean that a receiver (e.g., a user equipment) receives the corresponding information from the transmitter through higher-layer signaling, and this expression may be used interchangeably with other terms having the same or substantially similar meanings.

In addition, the term “not perform” used in the description or claims may be understood, according to the context, to mean omitting or skipping the corresponding operation. This expression may be used interchangeably with other terms having the same or substantially similar meanings

In the present disclosure, a base station may be embodied as an entity that is configured to allocate resources to terminals, and may be at least one of a gNode B (gNB), an eNode B (eNB), a Node B, a base station (BS), a wireless access unit, a base station controller, and a node on a network.

A terminal may be embodied as a user equipment (UE), a mobile station (MS), a cellular phone, a smartphone, a computer, or a multimedia system capable of performing a communication function.

In the disclosure, a “downlink (DL)” may refer to a radio link via which a base station transmits a signal to a terminal, and an “uplink (UL)” may refer to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include the 5th generation (5G) mobile communication technology (new radio, NR) developed beyond LTE-A, and in the following description, the “5G” may be the concept that covers the conventional LTE, LTE-A, and other similar services. In addition, based on determinations by those skilled in the art, the disclosure may also be applied to other communication systems through some modifications without significantly departing from the scope of the disclosure.

Hereinafter, various embodiments will be described with reference to the accompanying drawings. In the accompanying drawings, the same or like elements are designated by the same or like reference label as much as possible. Also, it should be noted that the following accompanying drawings of the disclosure are provided to help an understanding of the disclosure and the disclosure is not limited to configurations or arrangements illustrated in the drawings of the disclosure. In addition, a detailed description of known functions or configurations that may make the subject matter of the disclosure unclear will be omitted. It should be noted that in the following description of the disclosure, only parts necessary for understanding operations according to various embodiments of the disclosure will be described and descriptions of the other parts will be omitted so as not to make the subject matter of the disclosure obscure.

The disclosure relates to a technology regarding a polar code, which is one of error-correcting codes of a 3GPP NR standard.

The disclosure may be applied to a system in which a transmitter concatenates a CRC to a message bit to be transmitted, performs masking with a unique identification (ID) for each receiver, and then applies polar encoding.

The disclosure may be applied to a polar coding and decoding system of an NR PDCCH. In the NR PDCCH, a 16-bit radio network temporary identifier (RNTI) uniquely assigned to each UE is used for CRC masking, and the standard has been specified such that, even if one UE receives and attempts to decode a PDCCH signal of another UE, the decoding will not be successful. Various methods have been studied as decoding methods for polar codes, but a CRC-aided successive cancellation list (CSCL) decoding method, which provides error correction, is considered to be a representative decoding method. However, the CSCL decoder may be vulnerable to a false alarm because it generates a number of decoding output candidates equal to a list size and may perform CRC checks up to the maximum list size.

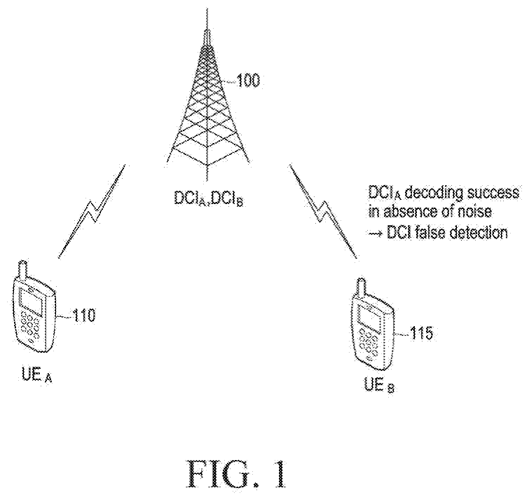

FIG. 1 illustrates an example of an operation of transmitting a PDCCH including downlink control information (DCI) for each of UE A and UE B to UE A and UE B in a wireless communication system according to an embodiment of the disclosure.

As illustrated in FIG. 1, a base station 100 may generate DCI for each of UE A 110 and UE B 115 and may transmit the generated DCI through a PDCCH. For illustrative purposes, FIG. 1 shows one base station 100 and two UEs 110 and 115. In some embodiments, a wireless communication system may include any number of base station and UEs.

In some embodiments, the base station 100 may add a 24-bit cyclic redundancy check (CRC) to each DCI, and then mask the CRC by using a unique ID of each UE, and may transmit the same through the PDCCH. The unique ID may be embodied as a cell radio network temporary identifier (C-RNTI). In some embodiments, the base station 100 may add a CRC including a different number of bits to each DCI.

This configuration may allow each UE to identify DCI corresponding to itself by using a CRC masked by its own C-RNTI, and accordingly, obtain resource allocation and control information of a PDSCH or a physical uplink shared channel (PUSCH).

Assuming that transmission parameters, other than the CRC masking, for the UE A 110 and the UE B 115 illustrated in FIG. 1 are the same, false alarm cases in which UE A 110 decodes a signal of UE B 115, even in the absence of noise, may occur.

In some embodiments, a method for allocating an appropriate masking pattern to UEs so as to prevent occurrence of a false alarm may be provided.

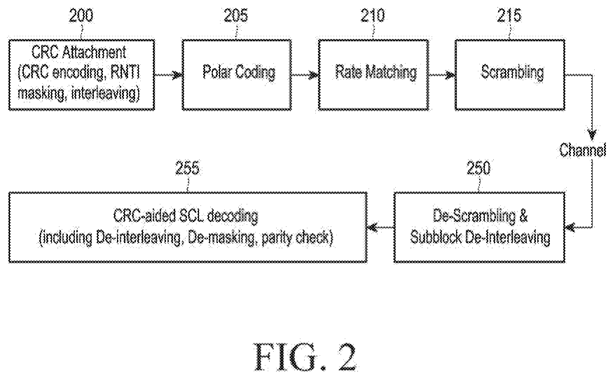

FIG. 2 illustrates an example of a block diagram of polar encoding and decoding operations of a NR PDCCH in an NR communication system.

In some embodiments, a polar coding and decoding system may be divided into a transmitter and a receiver. In some embodiments, a first device may include the transmitter and a second device, separate from the first device, may include the receiver.

Referring to FIG. 2, the transmitter may include a CRC attachment unit 200, a polar coding unit 205, a rate matching unit 210, and a scrambling unit 215. In addition, the receiver may include a de-scrambling and subblock de-interleaving unit 250 and a CRC-aided SCL (CSCL) decoding unit 255.

The polar coding and decoding system illustrated in FIG. 2 is an illustrative example. In some embodiment, the polar coding system may include various structures. For example, the polar encoding and decoding operations of the NR PDCCH may omit a CRC interleaving or scrambling operation at the transmitter.

Each of the objects illustrated in FIG. 2 may perform one or more of the following operations.

The CRC attachment unit 200 may perform cyclic redundancy check (CRC) encoding on an information bitstring to be transmitted. The CRC attachment unit 200 may perform CRC masking by using a radio network temporary identifier (RNTI), which is an identifier of a reception UE. In some embodiments, the reception UE may include the receiver. Thereafter, by performing interleaving with regard to the bitstring to which the CRC has been attached, an error dispersion effect during transmission can be obtained.

First, when a message bit of length A is represented as vector a, CRC encoding may refer to an operation of concatenating a CRC parity P vector of length P to vector a to generate a new vector b=(a:p). The CRC parity P may be generated differently according to a given CRC polynomial and a parity generation scheme.

Thereafter, a masking pattern may be applied to message bit a or CRC parity P. According to an embodiment, a method of applying a CRC masking pattern to CRC parity P will be described.

For example, in an NR PDCCH system, where P=24 and a 16-bit length masking pattern vector m=(m₁, . . . , m₁₆) may be added from the rightmost least significant bit (LSB) of CRC parity P through an XOR operation, as in Equation 1 below.

In vector b=(a:p), a vector obtained by adding masking pattern vector m=(m₁, . . . , m₁₆) from the rightmost least significant bit (LSB) of CRC parity P through an XOR operation may be referred to as vector c. In an embodiment, the vector c may be interleaved.

$$b = ( a : p ) = ( {a}_{1} , … , {a}_{A} , {p}_{1} , … , {p}_{8} , {p}_{9} … , {p}_{24} ) \qquad [ Equation 1 ]$$

$$\text{?} Bitwise XOR with m$$

$$c = ( {a}_{1} , … , {a}_{A} , {p}_{1} , … , {p}_{8} , {p}_{9} ⊕ {m}_{1} , … , {p}_{24} ⊕ {m}_{16} )$$

The polar coding unit 205 may perform polar coding on the masked bitstring, thereby providing an error correction capability through channel coding. Polar coding is an operation of generating vector d by multiplying vector c, for which the CRC masking has been performed, by matrix G having a size of K×N, where N is defined as N=2ⁿ, K=A+P for positive integer n. The matrix G is a matrix obtained by appropriately selecting K rows are from matrix G_{N} generated by performing n Kronecker operations on a 2×2 kernel matrix.

The rate matcher 210 may perform an operation of adjusting the length of a polar-coded generated codeword vector d to a size suitable for a transmission resource. This process may include a bit repetition, puncturing, or shortening operation, or the like. The final generated polar code word length may be defined as E.

The scrambling unit 215 may perform scrambling by using a random sequence in order to equalize the spectrum of the transmitted bit string and to protect the pattern. Thereafter, the scrambled bitstring may then be transmitted by the transmitter to the receiver through a channel.

The de-scrambling and subblock de-interleaving unit 250 included in the receiver may perform de-scrambling, based on a random sequence used for scrambling, for the received bit string, and perform de-interleaving for restoring a subblock-based interleaving structure applied during rate matching.

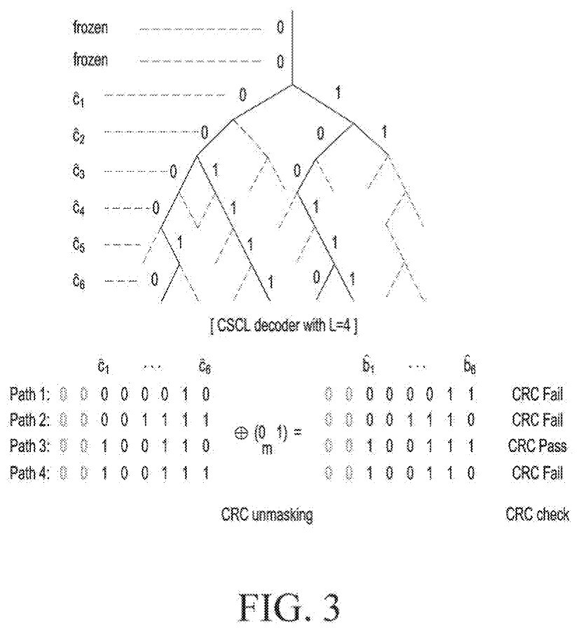

In the disclosure, a CSCL decoding method having an excellent error rate performance is considered to be a representative decoding technology. CSCL decoding is performed sequentially for each bit and has decoding paths of list size 1, and finally, a path satisfying the CRC among the L paths is the final decoding output. For example, the CSCL decoding operation for N=8, K=6, and a 2-bit RNTI m=(0,1) is illustrated in FIG. 3.

The CRC-based SCL decoding unit 255 may perform CRC-based successive cancellation list (SCL) decoding with respect to a de-interleaved bitstring. This process may include de-interleaving releasing, de-masking, and parity checking using the CRC. The SCL decoding may maintain multiple candidate paths to improve decoding performance.

FIG. 3 illustrates an example of CRC-aided SCL (CSCL) decoding in a wireless communication system.

FIG. 3 illustrates an example of a path expansion and selection operation according to a CRC-aided successive cancellation list (SCL) decoding scheme in a wireless communication system. More specifically, FIG. 3 illustrates a decoding operation for a case where the code block length N=8, the number of information bits K=6, and the 2-bit length RNTI is configured as m=(0,1) in an SCL decoding scheme based on a polar code. In some embodiments, the code block length and the number of information bits may be implemented as any number.

As illustrated in FIG. 3, the SCL decoder may expand multiple candidate paths in a tree structure by assuming 0 and 1 for each possible bit position, with regard to the received bitstring, and may maintain only lower L paths based on a path metric calculated at each node and remove the remaining paths. The removed paths are illustrated in FIG. 3 as dotted lines.

Thereafter, the CRC-aided SCL decoding may determine whether the received data bit string has been correctly decoded by performing a CRC parity check for each expanded candidate path. The CRC check may be performed to verify CRC bits included in decoding results of respective paths, through a pre-defined CRC generating polynomial.

Referring to FIG. 3, only one of a total four final candidate paths satisfies the CRC, and the remaining paths are discarded due to CRC errors. The decoder may select, when there are multiple candidates in which the CRC check has been successful, a path having the lowest path metric among the corresponding candidates as a final decoding result. This CRC-aided SCL decoding scheme may significantly reduce the possibility of selecting an erroneous path, and may improve the error correction performance of a polar code, compared to a simple SCL decoding.

The CSCL decoder may obtain an excellent error performance by increasing the number of decoding paths as the list size is increased, but the decoding computational complexity also increases accordingly. As such, the UE may perform decoding by using a list size at an appropriate level. As illustrated in FIG. 1, when the base station (transmitter) 100 transmits a signal to UE (receiver) A 110 and UE (receiver) B 115, it is assumed that, except for CRC masking for each receiver, all other transmission parameters are the same. In most transmission cases, since the CRC masking pattern of each receiver is different, UE A is unable to decode the signal of UE B, but may successfully decode the signal in a specific case.

For example, as in the case in which the RNTI is m=(0,1) in FIG. 3, if a receiver attempts CRC unmasking with m=(0,0), the existing CRC-passed Path 3 may fail the CRC, and Path 4 may pass the CRC. That is, even when the decoding is attempted with a different RNTI value, the CRC is passed, and the transmitted message is accurately decoded. This phenomenon is a problem of unintentionally detecting a message of another receiver, and if DCI is incorrectly detected, unnecessary PDSCH decoding attempts are made, whereby communication efficiency can be degraded, or it may also be connected to a security problem.

Therefore, the embodiments described herein provide a method for appropriately allocating a masking pattern for each receiver at a transmitter to help prevent the false detection phenomenon mentioned above.

The embodiments described herein provide a method for allocating a masking pattern so as to help prevent occurrence of a false detection phenomenon. The method include analyzing the Hamming distance characteristic of a polar code and a CSCL decoding algorithm which is a typical decoding algorithm of a polar code, and analyzing the influence of the Hamming distance of two arbitrary masking patterns on actual CSCL decoding. In one embodiment, method to help to help prevent occurrence of false detection includes to apply scrambling in a different manner for each receiver. In some embodiments, the method may include applying scrambling in addition to masking. In addition, the embodiments described herein may be used in a situation in which masking is needed to prevent false detection, according to future 6G standards, communication operation scenarios, and the like.

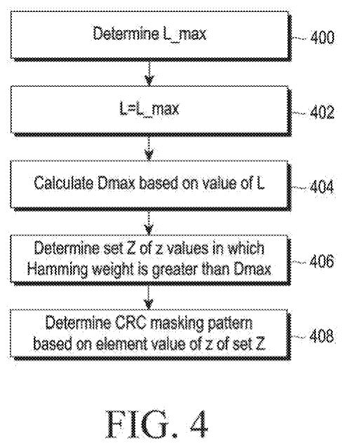

FIG. 4 is a flowchart illustrating an operation of determining a CRC masking pattern by a transmitter (e.g., a base station) according to an embodiment of the disclosure.

Referring to FIG. 4, in operation 400, the transmitter may determine a (expected) maximum list size Lₘₐₓ (e.g., Lₘₐₓ=32) used by a receiver's CSCL decoder.

In operation 402, the transmitter may substitute the maximum list size Lₘₐₓ used in the determined CSCL decoder for an L value used to determine the CRC masking pattern.

In operation 404, the transmitter may determine a maximum value Dₘₐₓ of a Hamming distance between a transmitted codeword cₜ and codewords cₗ (l=1, . . . , Lₘₐₓ) generated by decoding the CSCL of a list size L based on the L value substituted with Lₘₐₓ.

More specifically, the transmitter may determine the maximum value Dₘₐₓ of the Hamming distance by using Equation 2 below, when, for a given message bit length K and a final codeword length E of polar coding, an arbitrary signal without noise is generated, the codewords generated by CSCL decoding of a list size Lmax are expressed as cₗ, l=1, . . . , Lₘₐₓ, the transmitted codeword is expressed as cₜ, and the Hamming distance between two codewords is expressed as a function w(⋅,⋅).

$${D}_{max} = {max}_{l ∈ \{ 1 , … , {L}_{max} \}} w ( {c}_{i} , {c}_{t} ) \qquad [ Equation 2 ]$$

In operation 406, the transmitter may determine set Z of z values, in which the Hamming weight is greater than maximum value Dₘₐₓ of the Hamming distance, among z values corresponding to difference vector m_{d} of the two masking pattern vectors for the given value (K, E).

In an embodiment, the transmitter may indicate all possible masking difference vectors obtainable by a bitwise XOR of a given value (K, E) and two arbitrary masking pattern vectors mⁱ, m^{j} as m_{d} due to the characteristics of binary operations, and may calculate the same by using the offset vector o_{d}=[0 m_{d}]G_{K,E}.

Here, in order to simply express the vector m_{d}, a decimal number z corresponding to the vector m_{d} may be introduced and expressed as m_{d}(z). For example, if the length of the masking pattern vector is M=5, it corresponds to m_{d}(3)=(0, 0, 0, 1, 1). Similarly, the corresponding offset vector may be expressed as o_{d}(z)=[0 m_{d}]G_{g,E}. In addition, G_{K,E} is a matrix in which K rows are selected from G_{N} according to a determined polar code rule for the given value (K, E), and 0 is an all-zero row vector having the length of K−size(m_{d}(z)).

The transmitter may find Z in which a value of the Hamming weight H(o_{d}(z))=w(o_{d}(z),0) of o_{d}(z) and z=0 . . . , 2^{M}−1 is greater than Dₘₐₓ. The Hamming weight of the o_{d}(z) and z=0, . . . , 2^{M}−1 may indicate the number of bits having a value of 1 in a binary vector corresponding to the given offset vector. This is expressed by Equation 3 below.

$$ℤ {=}^{Δ} \{ z ∈ \{ 1 , … , {2}^{M} - 1 \} : H ( {o}_{d} ( z ) ) > {D}_{max} , \} \qquad [ Equation 3 ]$$

Although the masking pattern vector is assumed to be added to the end part of the K bit polarity-encoded bit in the embodiments described here, the same principle may be applied to find a set even when the masking pattern vector is added to a different position, and the disclosure is not limited thereto.

In operation 408, the transmitter may determine a CRC masking pattern, based on an element value z of the determined set [symbol] .

In an embodiment, when the transmitter determines a masking pattern of two or more receivers having the same value (K, E), the difference of masking pattern vectors of any two receivers may be configured to differ by m_{d}(z) for z∈ [symbol] . In an embodiment, if a masking pattern vector of arbitrary receiver A is selected as m^{A}=(m^{A}₁, . . . , m^{A}₁₆), the masking pattern vector m^{B}=(m^{B}₁, . . . , m^{B}₁₆) of receiver B having the same value (K, E) may be configured such that a distance between m^{A} and m^{B} is different by m_{d}(z). Here, the value Z may correspond to one of the elements of the set [symbol] obtained in Equation 3. If the number of masking pattern vectors to be generated is N, a masking pattern may be configured so that the difference is m_{d}(z) for _{N}C₂ vector pairs.

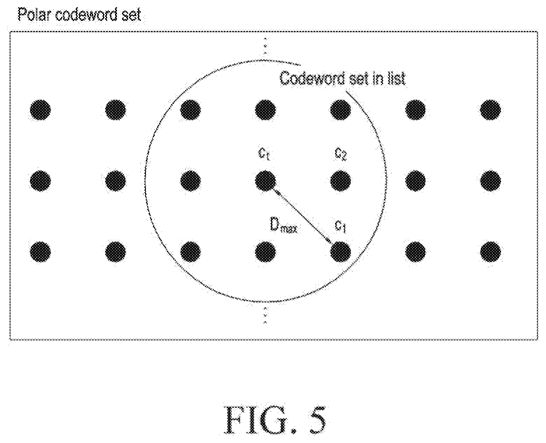

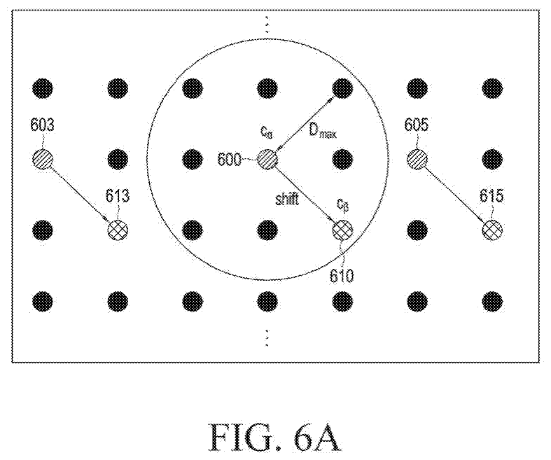

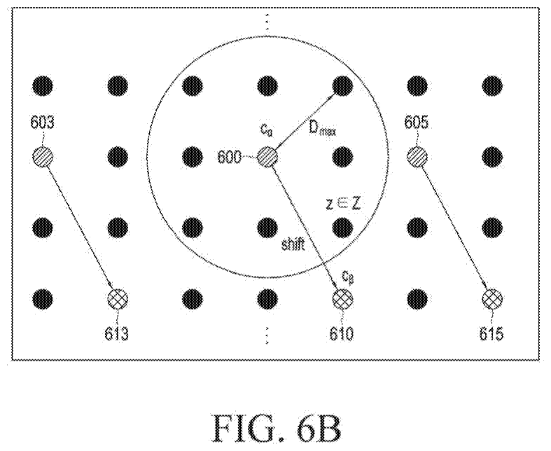

Hereinafter, FIG. 5, FIG. 6A, and FIG. 6B illustrate and describe the Hamming distance of the polar codewords in the operation of configuring the receiver-specific masking pattern illustrated in FIG. 4 above.

FIG. 5 illustrates a set of polar codewords when a CSCL decoder having a list size Lₘₐₓ is used according to an embodiment of the disclosure.

FIG. 5 illustrates determining a maximum value Dₘₐₓ of the Hamming distance between transmitted codeword cₜ and codewords l=1, . . . , Lₘₐₓ generated by decoding the CSCL of a list size L based on the L value substituted with Lₘₐₓ, in operation 404 of FIG. 4.

Referring to FIG. 5, in the decoder, a list of candidate codewords is formed, and the list may include L candidate codewords cₗ, l=1, . . . , Lₘₐₓ, i.e., from c₁ to c_{L}, and may be illustrated as a set of codewords in the list, which is based on the transmitted codeword cₜ. Here, cₜ denotes a codeword transmitted by the transmitter, and cₗ, l=1, . . . , Lₘₐₓ denotes candidate codewords generated inside the decoder.

In this case, each candidate codeword may be determined with reference to the Hamming distance from the transmitted codeword cₜ, and the Hamming distance may be a value indicating the distance between the transmitted codeword cₜ and the corresponding candidate codeword in the list. The Dₘₐₓ of FIG. 5 may indicate a maximum Hamming distance among the Hamming distances between the transmitted codeword cₜ and the candidate codewords, and may be used as an indicator for quantifying the clustering degree of the transmitted codewords in the list.

FIGS. 6A and 6B illustrate cyclic redundancy check (CRC) pass codewords c_{α} and c_{β} generated by a transmitter (e.g., a base station) by using masking pattern vectors m^{A} and m^{B} according to an embodiment of the disclosure.

FIGS. 6A and 6B illustrate an operation of determining set [symbol] of z values, in which the Hamming weight is greater than maximum value Dₘₐₓ of the Hamming distance, among z values corresponding to difference vector m_{d} of the two masking pattern vectors for the given value (K, E), in operation 406 of FIG. 4.

FIG. 6A illustrates a case in which a transmitter (for example, a base station (gNB)) transmits masked polar code word c_{α} to a receiver (for example, a UE A), based on masking pattern vector m^{A}.

Referring to FIG. 6A, (K, E) polar codeword vectors 600, 603, 605, 610, 613, and 615 may indicate polar codeword vectors that pass the CRC.

The polar codeword vectors 600, 603, and 605 show a case in which the masking pattern vector is m^{A} among the polar codewords that pass the CRC, and among the polar codeword vectors 600, 603, and 605, c_{α} 600 indicates a codeword transmitted from the transmitter among the polar codewords in which the masking pattern vector is m^{A}. In addition, the polar codeword vector c_{β}610 indicates a transmitted codeword among the polar codewords in which the masking pattern vector is m^{B}.

For example, when receiver B receives c_{α} 600, the Hamming distance between c_{β} 610 and c_{α} 600 is Dₘₐₓ, and thus c_{β} 610 may be one of the candidate codewords included in the codeword list after polar list decoding of size L. Therefore, descrambling c_{β} 610 with pattern m^{B} allows CRC pass, and thus even if receiver B receives c_{α} 600 from the transmitter, receiver B decodes c_{β} (610) as the received data, which may causing a false detection.

FIG. 6B illustrates a case in which a transmitter (for example, a base station (gNB)) transmits masked CRC-masked polar code word c_{α} to a receiver (for example, a UE A), based on masking pattern vector m^{A}, but masking pattern vector m^{B} is configured in consideration of maximum value Dₘₐₓ of the Hamming distance of codewords generated by CSCL decoding as in operation 406 of FIG. 4.

That is, FIG. 6B corresponds to a case of configuring mask pattern vectors m^{A} and m^{B} so that the Hamming weight of the z value corresponding to difference vector m_{d} between mask pattern vector m^{A} and mask pattern vector m^{B} is greater than maximum value Dₘₐₓ of the Hamming distances between the codewords generated by CSCL decoding having list L.

Referring to FIG. 6B, polar code vectors 600, 603, and 605 illustrate a case in which the masking pattern vector is m^{A} among the polar codewords that pass the CRC, and among the polar codeword vectors 600, 603, and 605, c_{α} 600 indicates a codeword transmitted from the transmitter among the polar codewords in which the masking pattern vector is m^{A}. In addition, c_{β} 610 indicates a transmitted codeword among the polar codewords in which the masking pattern vector is m^{B}.

In this case, the Hamming distance between codeword vectors c_{β} 610 and c_{α} 600 is greater than Dₘₐₓ, and thus if receiver B has received c_{α} 600, c_{β} 610 is not included in the codeword list after CSCL decoding of size L. Therefore, in case that receiver B descrambles a codeword list of CSCL decoding by using masking pattern vector m^{B}, CRC failure occurs and thus no false detection occurs.

Hereinafter, an NR PDCCH system will be described in more detail, as an example, based on the contents described in FIGS. 4, 5, 6A, and 6B.

In particular, FIG. 4, FIG. 5, FIG. 6A, and FIG. 6B have described a case of fixed (K, E), but in an actual communication system, since there are many values of (K, E), it is necessary to expand the corresponding contents by the number of the values. Therefore, all configurable (K, E) numbers are represented as Y, and the description is made by indexing y=1, 2, . . . , Y. In addition, in the NR PDCCH system, P=24 is fixed, the description is made by replacing with (A, E) for description based on a DCI size, and the masking pattern vector is replaced by the RNTI.

In the NR standard, there are various types of RNTIs, and in the disclosure, an RNTI that may be allocated differently for each UE is considered, which may be, for example, a C-RNTI or an MCS-C-RNTI. The RNTI value is determined by the base station and then notified to the UE, and is allocated so that each UE can properly distinguish its own DCI, by considering (A, E) parameter configurable when the RNTI is determined. If DCI is not distinguished and an error occurs, this may lead to a reduction in the throughput due to a system malfunction, and thus the disclosure may also be applied from the viewpoint of preventing this.

The first stage of an operation of configuring a masking pattern vector provided by the embodiments described herein is to determine maximum (estimated) list size Lₘₐₓ used in a CSCL decoder of a UE (receiver), and operation 400 described in FIG. 4 may be referred to.

In an embodiment, if Lₘₐₓ is accurately known by any method, the information may be used as it is, or Lₘₐₓ may be conservatively configured after synthesizing various information, experimental results, etc.

In an embodiment, Lₘₐₓ may be information determined in advance in order to determine Dₘₐₓ in the second stage. In some embodiments, Dₘₐₓ is determined by a different method, the first stage may be omitted. In the disclosure, Lₘₐₓ=32 may be assumed based on the contents discussed when the polar coding was standardized in NR. Since there is a disadvantage that as Lₘₐₓ is conservatively configured (i.e., as is configured to have a larger value), the size of set Z is reduced and the configuration of a masking pattern (e.g., RNTI) is more restricted, it is necessary to appropriately configure Lₘₐₓ. However, if the size of set Z can be small, then configuring Lₘₐₓ as conservative as possible is a method for certainly reducing the false detection probability. As another method, after Lₘₐₓ is set to a maximum value, then a RNTI set may be obtained, and if the number of RNTIs in the set is smaller than the number of users (or UEs) considered, the value of Lₘₐₓ may be reduced to obtain the RNTI set.

The second stage of the operation of configuring the masking pattern vector proposed in the disclosure is to determine Dₘₐₓ by using Equation 2 and CSCL decoding of list size Lₘₐₓ after random signal transmission for all (A, E) combinations configurable in the system, and operation 404 described in FIG. 4 may be referred to.

Table 1 below is an example in which Dₘₐₓ is determined for various (A, E) combinations. “Agg.” indicates an aggregation level in the NR specification, and experiments were conducted in consideration of maximum DCI size A being 140. In Table 1, the number of combinations of (A, E) is a total of 18, but if the total number of all combinations is denoted as Y, then

$${D}_{max}^{y}$$

may be calculated with respect to y=1, . . . , Y. In general, the larger Lₘₐₓ is, the smaller A is (i.e., the shorter the message length is), and the larger Dₘₐₓ is.

TABLE 1

| | A = 45 | A = 60 | A = 75 | A = 90 | A = 105 |
|---|---|---|---|---|---|
| E = 108 (Agg. 1) | 8 | 4 | 2 | N/A | N/A |
| E = 216 (Agg. 2) | 16 | 16 | 8 | 8 | 8 |
| E = 432 (Agg. 4) | 64 | 32 | 32 | 32 | 32 |
| E = 864 (Agg. 8) | 64 | 32 | 32 | 32 | 32 |

Dₘₐₓ according to (A, E) combinations in NR PDCCH system.

The third stage of the operation of configuring the masking pattern vector provided in the embodiments described herein is to calculate, using a RNTI difference vector, a difference between codeword sets for each RNTI for all (A, E) combinations configurable in the system, and operation 406 described in FIG. 4 may be referred to.

The difference between the polar codeword sets for RNTI differential vector m_{d}(z)=mⁱ⊕m^{j} is given in Equation 4 below.

$${c}_{i} {G}_{A , E} = {x}_{i} \qquad [ Equation 4 ]$$

$${c}_{j} {G}_{A , E} = ( {c}_{i} + [ 0 {m}_{d} ( z ) ] ) {G}_{A , E} = {x}_{i} + {o}_{d} ( z )$$

Since the RNTI in the NR PDCCH is 16 bits, difference vector m_{d}(z) of any two RNTI vectors may have a binary vector value corresponding to decimal numbers from 0 to 65,535 according to z=0~65535(2¹⁶−1). Therefore, offset vector o_{d}(z) may also be calculated by an equation of [0 m_{d}(z)]G_{A,E}. In addition, according to the above definition, if the total number of (A,E) combinations of is Y, an offset vector can be obtained for (A, E)_{y} in each case, and thus the offset vector can also be obtained for index y and may be denoted by

$${o}_{d}^{y} ( z ) .$$

In conclusion, [symbol] is obtained as in Equation 5 below, by referring to Equation 3.

$${ℤ}^{y} = \{ z ∈ \{ 0 , … , {2}^{M} - 1 \} : H ( {o}_{d}^{y} ( z ) ) > {D}_{max}^{y} , \} \qquad [ Equation 5 ]$$

$$for u = 1 , … , Y$$

The fourth stage of the operation of configuring the masking pattern vector provided in the embodiments described herein is to configure RNTIs of UE groups to which the same (A,E)_{y} is allocated so that the difference of RNTI vectors of two UEs belonging to the corresponding group becomes

$${m}_{d}^{y} ( z )$$

corresponding to one of the elements of set [symbol] , and the operations 406 and 408 described in FIG. 4 may be referred to.

When the configuration is made according to the method as described above and (A, E)=(45,108), an example of the results of an experiment in the case where a false alarm occurs and in the case where the false alarm does not occur is as follows in Table 2 and Table 3 below.

From the experimental results, it was confirmed that

$$H ( {o}_{d}^{y} ( z ) )$$

is 8 in z=3264, 3840, 3855, and since this value is the same as Dₘₐₓ=8, this is a case in which a false alarm occurs. On the other hand, it has been confirmed that no false detection occurs since

$$H ( {o}_{d}^{y} ( z ) )$$

is 16 or 32 in z=32, 48, 223, which is greater than Dₘₐₓ=8.

TABLE 2

| m^{A} | m^{B} | z | $H ( {o}_{d}^{y} ( z ) )$ |
|---|---|---|---|
| 2479 | 1711 (0 × 06AF) | 3840 | 8 |
| (0 × 09AF) | 1696 (0 × 06A0) | 3855 | 8 |
| | 1391 (0 × 056F) | 3264 | 8 |

Case where false detection occurs (A,E)=(45,108)

TABLE 3

| m^{A} | m^{B} | z | $H ( {o}_{d}^{y} ( z ) )$ |
|---|---|---|---|
| 2479 | 2463 (0 × 099F) | 48 | 32 |
| (0 × 09AF) | 2439 (0 × 0987) | 32 | 16 |
| | 2416 (0 × 0970) | 223 | 16 |

Case where no false detection occurs (A, E) (45,108)

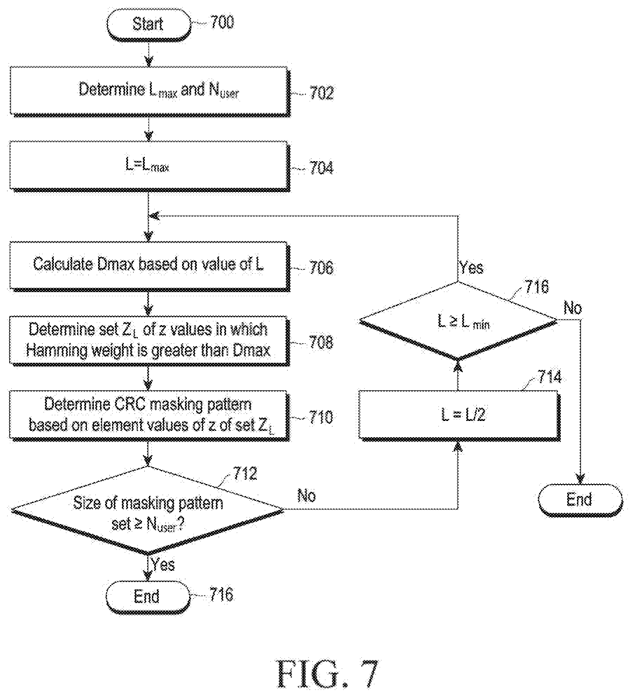

FIG. 7 is a flowchart illustrating an operation of determining a CRC masking pattern by a transmitter (e.g., a base station) according to an embodiment of the disclosure.

FIG. 7 is a flowchart illustrating a method for determining, when the number of UEs for transmitting DCI, based on the polar code (K, E), is Nᵤₛₑᵣ and a maximum configurable list size for SCL decoding is Lₘₐₓ, a set of masking patterns (e.g., RNTIs) for scrambling a CRC of a corresponding polar code.

Referring to FIG. 7, in operation 702, the transmitter (e.g., the base station) may determine a number of UEs to which DCI is to be transmitted or a number of receivers, and a maximum list size Lₘₐₓ.

In operation 704, the transmitter may substitute for L=Lₘₐₓ.

In operation 706, the transmitter may determine the maximum value cₜ among the Hamming distances between the transmission codeword cₜ and the codewords cₗ (l=1, . . . , L) generated by decoding the CSCL based on the value L configured in operation 704 and Equation 2 above.

In operation 708, the transmitter may determine, based on Equation 3, a set [symbol] ={z∈{1, . . . , 2^{M}−1}: H(o_{d}(z))>Dₘₐₓ} of z values in which the Hamming weight is greater than Dₘₐₓ obtained in operation 706.

In operation 710, the transmitter may configure, based on element z∈ [symbol] of set [symbol] determined in operation 708, a masking pattern so that the difference between the CRC masking patterns of two arbitrary receivers occurs by m_{d}(z). In some embodiments, a masking pattern set may be configured so that the difference is m_{d}(z) with respect to _{Nuser}C₂ vector pairs for the currently configured value Nᵤₛₑᵣ.

In operation 712, the transmitter may identify whether the size of the masking pattern set determined in operation 710 is greater than or equal to the number Nᵤₛₑᵣ of UEs to which a masking pattern (e.g., RNTI) needs to be allocated. If the size of the masking pattern set is greater than or equal to Nᵤₛₑᵣ, the transmitter may terminate the masking pattern determination process. If the condition is not satisfied, the transmitter may proceed to operation 714.

In operation 714, the transmitter may change to L=L/2 in order to design a needed number of masking patterns (e.g., RNTIs), and perform operation 716. That is, in case that the size of the masking pattern set determined in operation 710 is smaller than the number of UEs Nᵤₛₑᵣ to which a masking pattern (e.g., RNTI) needs to be allocated, the transmitter may decrease the list size of the CSCL decoder by L/2 to configure a masking pattern, based on a smaller maximum Hamming distance Dₘₐₓ. As an embodiment, L=L/2 is an example, and the transmitter may configure value L to a value smaller than the existing value L.

In operation 716, the transmitter may identify whether value L is greater than or equal to Lₘᵢₙ. The Lₘᵢₙ may be a value preconfigured for the minimum list size, and for example, may be 1.

If value L is greater than or equal to Lₘᵢₙ, the transmitter may repeatedly perform the operations of operations 706 to 716 until the mask pattern set size condition in operation 712 is satisfied.

If value L is less Lₘᵢₙ in operation 716, the transmitter may terminate the masked pattern determination process.

Thereafter, the transmitter may perform the RNTI masking operation in the CRC attachment unit 200, based on the determined masking pattern, as illustrated in FIG. 2, and may then transmit the codeword bitstring obtained after the polar encoding operation to the receivers via a channel.

A method performed by a transmission device to transmit a signal in a wireless communication system or a broadcasting system according to an embodiment of the disclosure is a method for determining (generating) an identifier, the method including configuring a Hamming distance between first and second identifiers so that the Hamming distance becomes a predetermined distance or more.

In an embodiment, the signal may be encoded by concatenating a polar code and a CRC code.

In an embodiment, the identifier may include a radio network temporary identifier (RNTI).

According to an embodiment, the predetermined distance may be determined based on code length E and information word length K of the polar code.

In an embodiment, the predetermined distance may be determined based on generator matrix G, code length E, and information word length K value of the polar code.

In an embodiment, the predetermined distance may be repeatedly adjusted based on the number of UEs, and the size of set Z for the first identifier and the second identifier may be optimized.

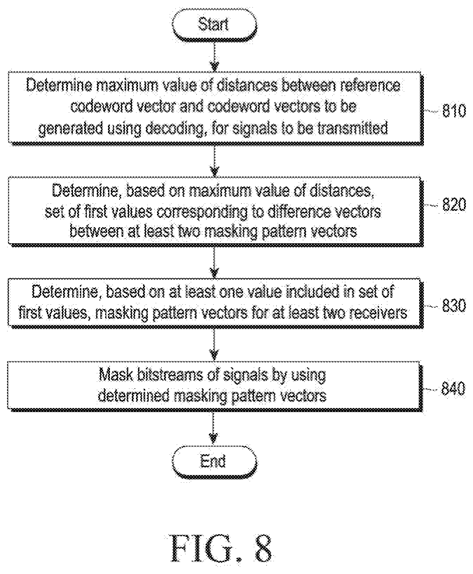

FIG. 8 is a flowchart illustrating an operation of a transmitter according to an embodiment of the disclosure.

Referring to FIG. 8, in operation 810, the transmitter may determine a maximum value of distances between a reference code vector and code vectors to be generated using decoding, for signals to be transmitted.

In operation 820, the transmitter may determine, based on a maximum value of the distances, a set of first values corresponding to difference vectors of at least two masking pattern vectors.

In operation 830, the transmitter may determine, based on at least one value included in the set of first values, masking pattern vectors for at least two receivers.

In operation 840, the transmitter may mask bitstreams of the signals by using the determined masking pattern vectors.

As an embodiment, the transmitter may generate codewords by encoding the masked bitstreams. As an embodiment, the transmitter may transmit the codewords to the at least two receivers.

As an embodiment, the transmitter may set a second value corresponding to a list size for the decoding.

As an embodiment, the transmitter may determine, based on the second value, a number of the codeword vectors to be generated using the decoding.

As an embodiment, an initial setting value of the second value may include a maximum value of a list size for the decoding.

As an embodiment, the transmitter may determine whether a size of the set of the masking pattern vectors is less than a number of the at least two receivers. As an embodiment, in response to the determining of the size of the set of the masking pattern vectors being less than the number of the at least two receivers, the transmitter may set the second value to a value smaller than a previously set value. As an embodiment, the transmitter may determine, based on the second value set to the smaller value, a number of the codeword vectors to be generated using the decoding.

As an embodiment, in case that the size of the set of the masking pattern vectors is less than the number of the at least two receivers, the transmitter may repeat setting the second value to a value smaller than a previously set value, and determine, based on the second value set to the smaller value, a number of the codeword vectors to be generated using the decoding until the size of the set of the masking pattern vectors is greater than or equal to the number of the at least two receivers.

As an embodiment, the transmitter may determine, among the first values, a set of values, in which converted values for the first values are greater than the maximum value of the distances.

As an embodiment, the decoding may include cyclic redundancy check (CRC)-aided successive cancellation list (CSCL) decoding, and the encoding may include polar coding.

As an embodiment, the maximum value of the distances may be determined based on bit length K of the signals to be transmitted and codeword length E of the polar code corresponding to the signals to be transmitted.

As an embodiment, the distances may include Hamming distances.

According to an embodiment, the masking pattern vectors may correspond to a radio network temporary identifier (RNTI).

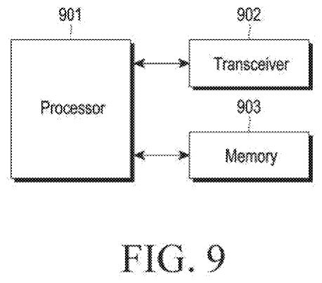

FIG. 9 is a block diagram illustrating a structure of a transmitter according to an embodiment of the disclosure.

The transmitter illustrated in FIG. 9 may include a base station.

Referring to FIG. 9, the transmitter includes one or more processors 901, a transceiver 902, and memory 903. The structure illustrated in the drawing corresponds to an embodiment, and the transmitter may further include a unit in addition to the one illustrated in FIG. 9. The transmitter illustrated in FIG. 9 may be an implementation example or implementation form of the transmitter described in the disclosure.

The transceiver 902 may transmit and receive a signal with another electronic device (e.g., a UE (receiver)). The memory 903 may store at least one of information related to the transceiver 902 and information transmitted and received through the transceiver 902. In addition, the memory 903 may store information on the masking pattern to which the disclosure is applied.

The one or more processors 901 may control the operation of the transmitter, and may control the entire transmitter so as to perform operations related to the transmitter in each of the above-described embodiments.

According to an embodiment of the disclosure, the memory 903 may store data such as basic programs, application programs, and setting information for operations of the electronic device. Particularly, the memory 903 may provide stored data upon the request of the one or more processors 901. The memory 903 may be configured by a storage medium such as a ROM, a RAM, a hard disk, a CD-ROM, and a DVD, or a combination of storage media. In addition, the memory 903 may include multiple memories. In addition, the processor 901 may perform the above-described embodiments, based on a program for performing the above-described embodiments stored in the memory 903, and may include at least one processor.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each element (e.g., a module or a program) of the above-described elements may include a single entity or multiple entities, and some of the multiple entities may also be separately disposed in another element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

What is claimed is:

1. A transmitter in a wireless communication system, the transmitter comprising:
a transceiver;
one or more processors including processing circuitry; and
memory storing instructions,
wherein the instructions, when executed by the one or more processors individually or collectively, cause the transmitter to:
for a plurality of signals to be transmitted, determine a maximum value of distances between a reference codeword vector and codeword vectors to be generated using decoding,
determine a set of first values corresponding to difference vectors between at least two masking pattern vectors, based on the maximum value of the distances,
determine masking pattern vectors for at least two receivers, based on at least one value in the set of first values, and
mask bitstreams of the plurality of signals, using the masking pattern vectors.

2. The transmitter of claim 1, wherein the instructions, when executed by the one or more processors individually or collectively, cause the transmitter to:
generate codewords by encoding the masked bitstreams, and
transmit the codewords to the at least two receivers.

3. The transmitter of claim 1, wherein the instructions, when executed by the one or more processors individually or collectively, cause the transmitter to:
set a second value corresponding to a list size for the decoding, and
based on the second value, determine a number of the codeword vectors to be generated using the decoding.

4. The transmitter of claim 3, wherein an initial setting value of the second value includes a maximum list size for the decoding.

5. The transmitter of claim 3, wherein the instructions, when executed by the one or more processors individually or collectively, cause the transmitter to:
determine whether a size of a set of the masking pattern vectors is less than the number of the at least two receivers,
in response to determining that the size of the set of the masking pattern vectors is less than the number of the at least two receivers, set the second value to a smaller value than a previously set value, and
based on the second value being set to the smaller value, determine a number of the codeword vectors to be generated using the decoding.

6. The transmitter of claim 5, wherein the instructions, when executed by the one or more processors individually or collectively, cause the transmitter to:
until the size of the set of the masking pattern vectors is greater than or equal to the number of the at least two receivers, repeat:
in response to determining that the size of the set of the masking pattern vectors is less than the number of the at least two receivers, setting the second value to a smaller value than a previously set value, and
based on the second value being set to the smaller value, determining a number of the codeword vectors to be generated using the decoding.

7. The transmitter of claim 1, wherein the instructions, when executed by the one or more processors individually or collectively, cause the transmitter to:
determine a set of values among the set of first values whose transformed values are greater than the maximum value of the distances.

8. The transmitter of claim 1, wherein the decoding includes cyclic redundancy check (CRC)-aided successive cancellation list decoding, and the encoding includes polar encoding.

9. The transmitter of claim 1, wherein the maximum value of the distances is determined based on a bit length of the plurality of signals to be transmitted and a codeword length of a polar code corresponding to the plurality of signals to be transmitted.

10. The transmitter of claim 1, wherein the distances include Hamming distances.

11. The transmitter of claim 1, wherein the masking pattern vectors correspond to a radio network temporary identifier.

12. A method performed by a transmitter in a wireless communication system, the method comprising:
for a plurality of signals to be transmitted, determining a maximum value of distances between a reference codeword vector and codeword vectors to be generated using decoding;
based on the maximum value of the distances, determining a set of first values corresponding to difference vectors between at least two masking pattern vectors;
based on at least one value included in the set of first values, determining masking pattern vectors for at least two receivers; and
masking bitstreams of the plurality of signals by using the determined masking pattern vectors.

13. The method of claim 12, further comprising:
generating codewords by encoding the masked bitstreams; and
transmitting the codewords to the at least two receivers.

14. The method of claim 12, further comprising:
setting a second value corresponding to a list size for the decoding; and
based on the second value, determining a number of the codeword vectors to be generated using the decoding.

15. The method of claim 14, wherein an initial setting value of the second value comprises a maximum value of the list size for the decoding.

16. The method of claim 14, further comprising:
determining whether a size of a set of the masking pattern vectors is less than a number of the at least two receivers;
in response to determining that the size of the set of the masking pattern vectors is less than the number of the at least two receivers, setting the second value to a value smaller than a previously set value; and
based on the second value being set to the smaller value, determining a number of the codeword vectors to be generated using the decoding.

17. The method of claim 16, further comprising:
until the size of the set of the masking pattern vectors is greater than or equal to the number of the at least two receivers, repeat:
in case that the size of the set of the masking pattern vectors is less than the number of the at least two receivers, setting the second value to a value smaller than a previously set value, and based on the second value being set to the smaller value,
determining a number of the codeword vectors to be generated using the decoding.

18. The method of claim 12, wherein the determining of the set of first values corresponding to difference vectors between at least two masking pattern vectors, based on the maximum value of the distances, comprises determining, among the set of first values, a set of values, of which converted values for the set of first values are greater than the maximum value of the distances.

19. The method of claim 13, wherein the decoding comprises cyclic redundancy check (CRC)-aided successive cancellation list decoding, and the encoding comprises polar coding.

20. A non-transitory computer-readable storage medium storing at least one instruction which, when executed by at least a part of at least one processor of an electronic device, causes the electronic device to perform at least one operation,
wherein the at least one operation comprises:
for a plurality of signals to be transmitted, determining a maximum value of distances between a reference codeword vector and codeword vectors to be generated using decoding;
based on the maximum value of the distances, determining a set of first values corresponding to difference vectors between at least two masking pattern vectors;
based on at least one value included in the set of first values, determining masking pattern vectors for at least two receivers; and
masking bitstreams of the plurality of signals by using the determined masking pattern vectors.
